(19) United States
(12) Patent Application Publication
(10) Pub. No.: US 2009/0002429 A1
(43) Pub. Date: Jan. 1, 2009

(54) PRINTER CALIBRATION

(76) Inventors: Sergio Puigardeu, Barcelona (ES); Angel Martinez, Barcelona (ES); Eduardo Amela, Barcelona (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/142,673

(22) Filed: Jun. 19, 2008

(30) Foreign Application Priority Data
Jun. 29, 2007 (EP) 07111445.8

(51) Int. Cl. B41J 29/393

(52) U.S. Cl. 347/19

(57) ABSTRACT

A printer and method of calibrating such a printer is presented. The method comprises: printing a reference pattern on print media; depositing ink over the printed reference pattern; printing a test pattern over the deposited ink to form an interference pattern; and determining an ink density value that results in an acceptable deformation of the printing media based on an optical evaluation of the interference pattern.

This patent application claims priority from European Patent Application Serial No. 07111445.8, filed Jun. 29, 2007.

### FIELD OF THE INVENTION

This invention relates to the field of printing, and more particularly to the field of calibrating a printer.

### BACKGROUND

The quality of pictures, imagery and text printed by a printer is highly dependent on the accuracy of the printer. Calibration processes are used to improve the accuracy of printers, and such calibration processes typically comprise a variety of methods and/or measurements which are undertaken during or directly following the manufacture of a printer.

It is a recognized issue that the amount of ink deposited by printers may be excessive for cheap and thin printing media. When the quantity of deposited ink is too high, media is deformed causing a waviness known as cockle. If cockle height or amplitude is greater than the physical space between the printhead of the printer and the media (for example, around 1.2 mm), the printhead nozzle plate may touch the media while printing, creating an ink smearing on the printout. In addition to causing a defect in the print quality, the nozzle plate may be scratched. Such scratches can create directionality and nozzle health problems because media particles can get inside the nozzles/scratches and block them.

### BRIEF DESCRIPTION OF THE DRAWINGS

For a better understanding of the invention, embodiments will now be described, purely by way of example, with reference to the accompanying drawings, in which:

FIG. 1 illustrates a printer according to an embodiment of the invention;

FIG. 2 is a schematic section of a printer according to an embodiment of the invention;

FIG. 3 is a schematic view of a printhead according to an embodiment of the invention;

FIG. 4 is an illustration of an interference pattern according to an embodiment of the invention;

FIG. 5 is an illustration of an interference pattern according to an embodiment of the invention, wherein the base pattern has not been distorted before the test pattern was printed on the base pattern;

FIGS. 6a and 6b are exemplary interference patterns according to embodiments of the invention;

FIG. 7 illustrates determination of cockle based on a deformation of a reference pattern;

FIG. 8 is an illustration of a reference pattern according to an embodiment of the invention;

FIG. 9 shows ink deposited on the reference pattern of FIG. 6; and

FIG. 10 shows a test pattern printed on the ink and reference pattern of FIG. 9, thereby producing an interference pattern according to an embodiment of the invention.

### DETAILED DESCRIPTION OF THE INVENTION

According to an embodiment of the invention, there is provided a method of calibrating a printer comprising: printing a reference pattern on the print media; depositing ink over at least a portion of the printed reference pattern; printing a test pattern over the deposited ink to form an interference pattern; and determining an ink density value that results in a maximum acceptable deformation of the print media based on a optical evaluation of the interference pattern.

Thus, there is provided a way to automatically optimize the amount of ink deposited by a printer onto media in order to control and/or reduce an amount of cockle in the media.

Embodiments use an interference pattern, the interference pattern being printed onto media and then scanned by a sensor. Results from the scan can be analyzed and used to calibrate a density or amount of ink that can be deposited on the print media. A specific calibration method has, for example, been disclosed in EP1211084, where an interference pattern is used for linefeed calibration of a printer. It should be understood that the interference pattern may be built differently in alternative embodiments, for example as described in EP1211084.

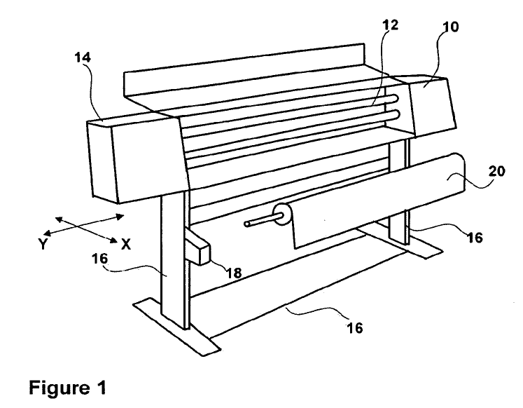

Referring to FIG. 1, a printer comprises a printing unit 10 having a print head (not visible) which is adapted to reciprocate along a scan axis assembly 12 within a housing 14. The printing unit 10 is supported on a framework 16 so that it is raised up from a floor or surface upon which the framework 16 is positioned. The framework 16 comprises a supporting assembly 18 for rotatably supporting a supply roll of print media 20 such that print media may be fed from the supply roll 20 to the printing unit 10.

The print media 20 is fed along a media axis denoted as the X axis. A second axis, perpendicular to the X axis, is denoted as the Y axis. The printhead reciprocates along a scan axis over print media 20 fed to the printer, wherein the scan axis is parallel to the Y axis.

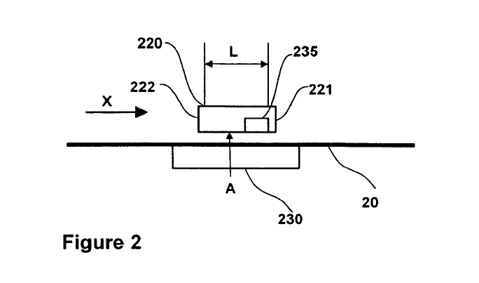

FIG. 2 schematically represents the print media 20 being fed to the printer between a printhead 220 and a platen 230. The print media 20 is extracted from a supply roll of media and advances onto the platen 230. The direction of media advance is the X direction or X axis. Any suitable mechanism for advancing the medium may be used, such as a drive and pinch roller arrangement. As the print media 20 passes between the printhead 200 and the platen, the printhead 220 reciprocates or scans along the media 20 along the Y direction or Y axis (which is in this case perpendicular to the X axis) and deposits ink onto the print media 20.

The printhead also comprises an optical sensor 235 which is adapted to optically evaluate patterns and/or ink printed on media (either by the same printhead or a different printhead). The optical sensor 235 can therefore be used to evaluate interference patterns, for example, in order to obtain information regarding an amount of distortion and/cockle introduced into the print media.

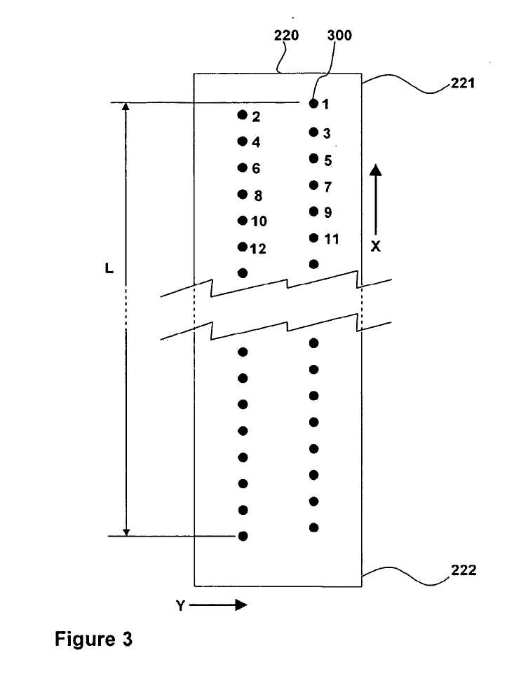

FIG. 3 schematically represents the bottom face of the printhead 220 as viewed from the direction of the arrow labeled “A” in FIG. 2. The printhead 220 comprises a plurality of nozzles 300. In this example, the head comprises five-hundred (500) functioning and active nozzles. In this case, the nozzles are arranged in two columns, each column carrying two-hundred and fifty (250) functioning and active nozzles. Not all nozzles are represented in FIG. 3: only the two opposite ends of the printhead are represented.

The nozzles are the printing elements and, as such, define the swath height of the printhead. The swath height is the length L (represented in FIGS. 2 and 3) taken along the X axis or medium advance direction which corresponds to the maximum width of a swath printed by the printhead when the printhead moves along the Y direction or scanning direction. If all nozzles of the printhead are functional and active, the swath height corresponds to the distance separating the extreme nozzles on both ends of the printhead along the X axis.

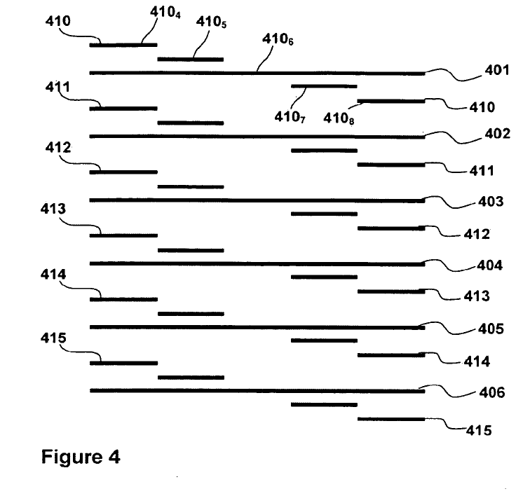

An interference pattern as represented in FIG. 4 is printed as follows according to an embodiment of the invention. In a first pass of the printhead (otherwise referred to as a first printing pass), the printhead prints a base pattern of parallel lines 401 to 406. These lines are printed using 6 nozzles separated by 10 nozzles. In the example, the printhead has two columns of nozzles, the nozzles being staggered. The nozzles of a first column are described with odd numbers starting from a first end 221 of the printhead 220 further away from the print media feeding mechanism (nozzles 1, 3, 5, 7 etc . . . ) and that the nozzles of a second column are described with even numbers starting from the same end 221 (2, 4, 6, 8, etc . . . ) such that along the X axis the nozzles follow each other in the order 1, 2, 3, 4, 5 etc . . . , the nozzle number 1 being located on the first end 221 of the printhead. Line 401 is printed by nozzle 6, line 402 is printed by nozzle 16, line 403 is printed by nozzle 26 etc . . . , so that the distance separating the lines corresponds to 9 nozzles (as the line fills the gap between on nozzle and the next).

In a second pass of the printhead (otherwise referred to as a second printing pass), the printhead deposits ink from all of the nozzles over the printed reference pattern. In other words, the reference pattern is overprinted with a quantity of ink. This ink should provoke media deformations, such as cockle, making the parallel lines distort, wherein the amount of deformation depends on the amount or density of the ink deposited in the second printing pass.

The second printing pass can be a uniform deposition of ink over the full area of the base pattern, or it may be a pattern which overprints one or more portions of the base pattern.

In a third printing pass, a test pattern is printed over the interference pattern and the ink deposited in the second printing pass. The test pattern is a stair step pattern formed by stairs 410 to 415. Each stair comprises steps, the steps being printed by consecutive nozzles, the central step of each stair being printed by the nozzle having printed the corresponding line of the base pattern. This means that stair 410 is printed using nozzles 2 to 10. Only the central steps printed by nozzles 4 to 8 are represented in FIG. 4 (steps 4104 to 4108). Stair 411 is printed using nozzles 12 to 20, and stair 412 is printed using nozzles 22 to 30, etc . . . (again, not all steps are shown in FIG. 4).

If no media deformations are caused by the ink deposited in the second printing pass, the step printed by nozzle 6 will exactly overlap the line printed by nozzle 6, the step printed by nozzle 16 will exactly overlap the line printed by nozzle 16, and the step printed by nozzle 26 will exactly overlap the line printed by nozzle 26, etc. (as illustrated in FIG. 4).

A lighter region of each interference pattern is created where steps of the stair are close to or align with the lines of the base pattern. The more there is an overlap between a line of the basic pattern and a step of the overlay pattern, the greater the area of unprinted space.

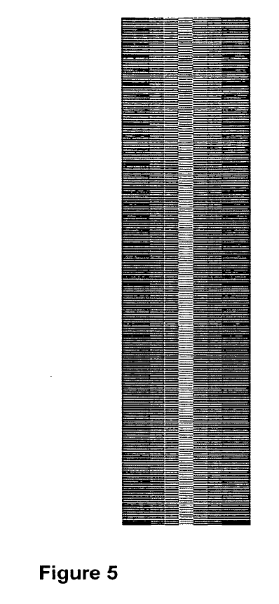

If the media is not deformed, all of the central steps will exactly overlap with the corresponding lines of the base pattern, therefore producing a straight lighter region in the middle of the interference pattern (as illustrated in FIG. 5)

In practice, the ink deposited in the second printing pass may cause media deformation, thereby meaning that the central steps of the test pattern do not align with the lines of the base pattern. Such distortion or misalignment therefore means that other steps of the test pattern are closer to or align with the lines of the base pattern. The lighter region will therefore be distorted by an amount proportional to the media distortion.

Actual resulting interference patterns are illustrated in FIGS. 5a and 5b, where all steps of the stairs are represented.

The interference patterns show a wavy signal comprising light and dark zones. The lighter or brighter zones correspond to low media deformation areas (where the base and stair step patterns align or match, leaving large gaps between lines).

The waviness of the lighter region (i.e. the amplitude of the wavy lighter zone) in the interference plot varies with the amount of ink deposited on the media in the second printing pass. A larger wave amplitude indicates a greater amount of media deformation or cockle. The magnitude or amplitude of the waves can be analyzed and/or determined by scanning the interference pattern with an optical sensor. Such an optical sensor may be adapted to determine the maximum offset at which a lighter region occurs, for example.

It should be understood, however, that a sensor of a conventional printer may be used, such as a line sensor. Conventional printers comprise such sensors for other calibration processes such as alignment, close loop color, etc.

An optical evaluation of the interference pattern may therefore enable the determination of an ink density value that results in an acceptable deformation of the print media.

Of course, more than one interference pattern may be printed, wherein each interference pattern is printed with a differing amount/density of ink being deposited in the second printing pass. Each interference pattern may then be scanned to determine the amount of deformation that is produced for a given amount/density of deposited ink. Thus, an ink limit for a media may therefore be determined by establishing a density of ink that provides a maximum acceptable deformation in the media.

The maximum acceptable deformation for a printer typically depends on the Printhead to Paper Spacing (PPS). Typical PPS values for printers may range from 1.5 to 1.7 mm. For some mechanical variability reasons, maximum allowable media deformations for this PPS range are around 1.2 mm.

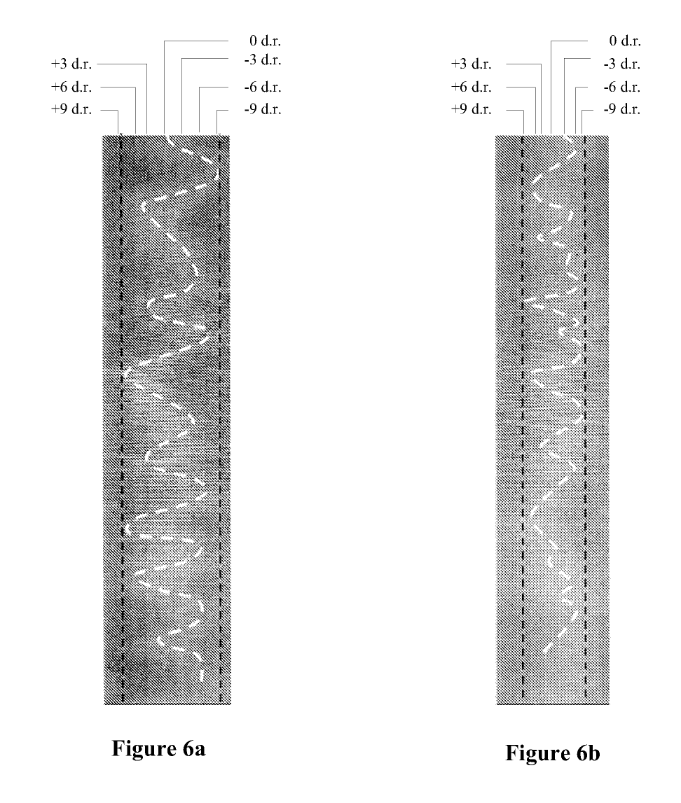

FIGS. 6a and 6b show actual interference patterns produced with 24 picolitre (pl) (one picolitre being 1*10⁻¹² liters) and 15 pl of ink deposited in the second printing pass, respectively, for a 600 dpi printhead. For ease of understanding each wavy lighter region is indicated by a dashed white line. Also, reference to 24 pl in this example, for instance, means depositing 24 pl of ink in a 1/600 by 1/600 inches square. Ink droplets deposited from a nozzle of a printhead may be 4 pl, 6 pl or 9 pl for example.

As seen in FIG. 6a, the cockle reaches 9 dot rows, that is 1.2 mm, when 24 pl of ink is deposited in the second printing pass. This may be an unacceptable level of cockle. However, from FIG. 6b, it can be seen that the cockle reaches 6 dot rows, that is 0.8 m, when 15 pl of ink is deposited in the second printing pass. This may be an acceptable level of cockle and the ink limit for the media may be set to such a value.

If an acceptable level of cockle lies between 1.2 mm and 0.8 mm, say 1.0 mm, interpolation may be used to determine an ink limit. For example, linear interpolation would indicate that an ink limit of 19.5 pl may be set for a maximum acceptable level of cockle of 1.0 mm. Of course, other suitable interpolation methods may be used to ascertain an ink limit for a given media based on interference patterns produced by differing amounts/densities of ink deposited in the second printing pass.

A light area in the interference pattern does not mean a peak or a valley of the cockle. It is, instead, the position where the base and test patterns have an improved overlay, and this is used as an indirect measure of Printhead to Paper Space.

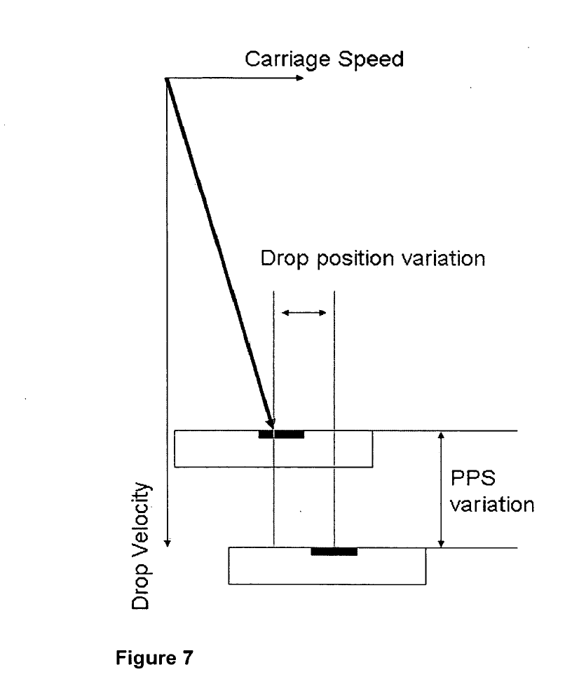

For example, referring to FIG. 7, when a 3 dot row offset from the centre or mean of the interference pattern is produced, the amount of cockle can be determined, taking into account a firing vector of the ink. In other words, by considering a vector describing the horizontal velocity of an ink droplet (caused by the horizontal velocity of the print head) and the vertical velocity of the ink droplet (caused by the ink droplet falling towards the media), the horizontal offset can be used to determine the vertical PPS spacing which matches the vector.

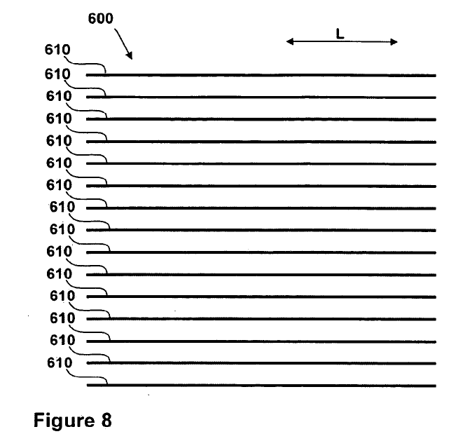

For a better understanding, a method of calibrating a printer according to another embodiment will now be described with reference to FIGS. 8 to 10.

First, a reference pattern 600 is printed on a print media as illustrated in FIG. 8. The reference pattern 600 comprises a plurality of spaced apart parallel lines 610, the lines 610 extending in a longitudinal direction (as indicated generally by the arrow labeled “L”).

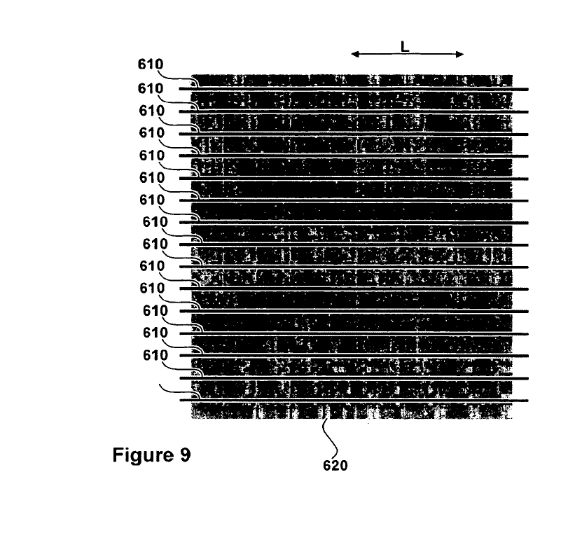

Next, one or more swathes of ink 620 are deposited over the printed reference pattern 600, as illustrated in FIG. 9. The deposited ink 620 is of a substantially uniform density. In other words, the ink 620 is deposited at a first density value. It should therefore be appreciated that the ink deposited over the printed reference pattern 600 may be deposited in more than one pass of the print head over the media. Thus, repeated printing passes may be completed in order to deposit a necessary of ink over the printed reference pattern. In other words, depositing ink over the reference pattern may comprise more than one printing pass.

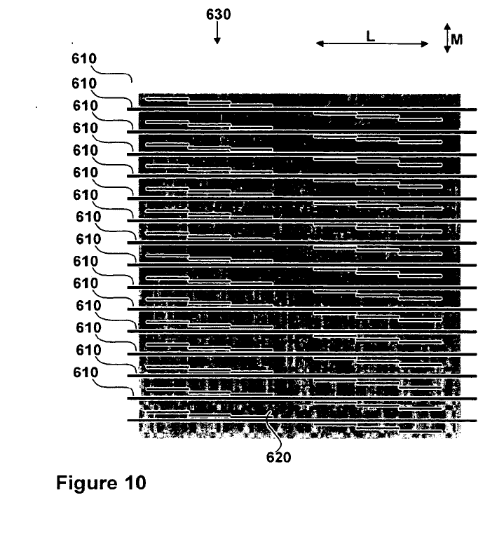

A test pattern 630 is then printed over the deposited ink to form an interference pattern (as shown in FIG. 10). The test pattern comprises a first row of spaced apart parallel lines extending longitudinally and a plurality of further rows of spaced apart parallel lines extending longitudinally, each further row being longitudinally offset from an adjacent row of spaced apart parallel lines and being laterally offset from the first row by a differing amount (the lateral direction being indicated generally by the arrow labeled “M”).

The lines of each row of the test pattern are spaced apart such that they have substantially the same spacing as the lines of the reference pattern. Further, the test pattern is printed such that the lines of the first row should substantially coincide with the lines of the reference pattern if the media is not deformed by the ink deposited in the second step of the method (i.e. no media cockle is present).

Thus, it will be appreciated that the test pattern is a stair step pattern, each stair comprising steps wherein a central step of each stair should correspond to a line of the reference pattern 600. If the position of a printed central step of a stair does correspond to that of a line of the reference pattern 600, it is determined that ink deposited in the second printing pass (i.e. after printing the reference pattern, but before printing the test pattern) has introduced a deformation in the print media. The distance by which such a central step is distorted or offset from the line of the reference pattern provides a measure of the deformation/cockle caused by ink deposited over the reference pattern.

Thus, an ink density value that results in an acceptable deformation of the printing media can be determined based on an optical evaluation of the printed interference pattern.

It will be appreciated that embodiments may automatically calculate an optimal amount of ink to avoid unacceptable levels of media cockle and the undesirable printing defects that unacceptable amount of cockle can create.

Embodiments therefore help to keep printhead nozzles from being scratched and/or damaged, so as to increase printhead lifetime and improve printing quality.

While specific embodiments have been described herein for purposes of illustration, various modifications will be apparent to a person skilled in the art and may be made without departing from the scope of the invention.

For example, more than one interference pattern may be printed on the same sheet of media, wherein each interference pattern is printed with a differing amount of ink being deposited over the reference pattern. In this way, the cockle caused by different ink amounts/densities for a given print media can be investigated without having to use multiple sheets of media.

Further, it should be understood that embodiments are not limited to printing an interference pattern in the direction of the media advance (i.e. the central light region extending along the x-axis). Alternative embodiments may print the pattern along the scan axis direction (i.e. the central light region extending along the y-axis.

We claim:

1. A method of calibrating a printer comprising:
printing a reference pattern on print media;
depositing ink over at least a portion of the printed reference pattern;
printing a test pattern over the deposited ink to form an interference pattern; and
determining an ink density value that results in an acceptable deformation of the print media based on an optical evaluation of the interference pattern

2. The method of claim 1, wherein the reference pattern comprises a plurality of spaced apart parallel lines, the lines extending in a longitudinal direction, and wherein the test pattern comprises a stair step pattern.

3. The method of claim 2, wherein the test pattern comprises:
a first row of spaced apart parallel lines; and
a plurality of further rows of spaced apart parallel lines, each further row being longitudinally offset from an adjacent row of spaced apart parallel lines and being laterally offset from the first row by a differing amount,
the spaced apart parallel lines of each row of the test pattern being spaced apart such that they have substantially the same spacing as the spaced apart lines of the reference pattern.

4. The method of claim 1, wherein the step of determining comprises:
evaluating the interference pattern using an optical sensor to obtain data relating to deformation of the print media; and
determining the ink density value by interpolating the obtained data.

5. The method of claim 1, wherein the step of depositing ink over at least a portion of the printed reference pattern comprising depositing ink in a plurality of printing passes.

6. The method of claim 1, wherein the optical evaluation of the interference pattern is undertaken using an optical sensor.

7. A computer program comprising computer program code means adapted to perform, when run on a computer, the steps of:
printing a reference pattern on print media;
depositing ink over at least a portion of the printed reference pattern;
printing a test pattern over the deposited ink to form an interference pattern; and
determining an ink density value that results in an acceptable deformation of the print media based on an optical evaluation of the interference pattern.

8. A printer comprising a print head adapted to print ink onto print media, wherein the printer is adapted to:
print a reference pattern on the print media;
deposit ink over at least a portion of the printed reference pattern; and
print a test pattern over the deposited ink to form an interference pattern,
and wherein the printer further comprises optical sensing means adapted to optically evaluate the interference pattern and to determine an ink density value that results in an acceptable deformation of the print media based on the optical evaluation.

9. The printer of claim 8, wherein the reference pattern comprises a plurality of spaced apart parallel lines, the lines extending in a longitudinal direction, and wherein the test pattern comprises a stair step pattern.

10. The printer of claim 9, wherein the test pattern comprises:
a first row of spaced apart parallel lines; and
a plurality of further rows of spaced apart parallel lines, each further row being longitudinally offset from an adjacent row of spaced apart parallel lines and being laterally offset from the first row by a differing amount,
the spaced apart parallel lines of each row of the test pattern being spaced apart such that they have substantially the same spacing as the spaced apart lines of the reference pattern.

11. The printer of claim 8, wherein optical sensing means are adapted to obtain data relating to deformation of the print media, and to interpolate the obtained data in order to determine the ink density value.

12. The printer of claim 8, wherein the printer is further adapted to deposit ink over at least a portion of the printed reference pattern in a plurality of printing passes.

13. The printer of claim 8, wherein the optical sensing means comprise an optical sensor housed in the print head.

14. A printing system comprising:
a printer comprising a print head adapted to print ink onto print media; and
a computer in communication with the printer, the computer being adapted to provide image data to the printer,
wherein the printer is adapted to:
print a reference pattern on the print media;
deposit ink over at least a portion of the printed reference pattern; and
print a test pattern over the deposited ink to form an interference pattern,
and wherein the printer further comprises optical sensing means adapted to optically evaluate the interference pattern and to determine an ink density value that results in an acceptable deformation of the print media based on the optical evaluation.
